(19) United States
(12) Patent Application Publication
(10) Pub. No.: US 2005/0210734 A1
(43) Pub. Date: Sep. 29, 2005

(54) Breakaway mink/muskrat trap support

(76) Inventors: Garrett J. Nowack, Spalding, MI (US); Joseph A. Nowack, Spalding, MI (US)

Correspondence Address: LITMAN LAW OFFICES, LTD, PO BOX 15035, CRYSTAL CITY STATION, ARLINGTON, VA, 22215, US

(21) Appl. No.: 11/077,207

(22) Filed: Mar. 11, 2005

Related U.S. Application Data
(60) Provisional application No. 60/555,701, filed on Mar. 24, 2004.

(51) Int. Cl. A01M 23/26

(52) U.S. Cl. 43/96; 43/88

(57) ABSTRACT

A support for mounting a Conbear-type animal trap within a culvert at about the water level near a wall thereof for trapping mink and muskrat which may be swimming through the culvert. An elongate body has a clamp at one end and a support or bracket at the other end for supporting the trap near a culvert wall. The support may be a breakaway type where in one embodiment a bracket holds the trap in a desired position and allows the trap to break away upon the trapping of an animal. In another embodiment a carriage bolt is a pivot pin in the jaw eyes of the trap, the carriage bolt being secured to the end of the elongate body. The bolt may be permanently secured by mounting through a throughbore in the body, or mounted for breakaway in a V-shaped groove in the end of the support body.

### CROSS-REFERENCE TO RELATED APPLICATION

This application claims the benefit of U.S. Provisional Patent Application Ser. No. 60/555,701, filed Mar. 24, 2004.

### BACKGROUND OF THE INVENTION

1. Field of the Invention

The present invention relates to animal trap supports. More particularly, the present invention relates to trap supports for mounting a Conibear trap to the side of a culvert or conduit carrying water.

2. Description of the Related Art

A variety of traps exist for trapping fur-bearing animals, many of which employ spring devices for closing jaws on a trapped animal. Traps for some animals require baiting, however, unbaited traps may be placed in known animal runways and waterways, the animal being snared as it displaces the trap trigger. The Conibear type trap is widely used as a humane trap which preserves the quality of the fur. This type of trap is disclosed in U.S. Pat. Nos. 2,947,107, and 3,010,247, the disclosures of which are hereby incorporated by reference. This type of trap is widely used in the underwater trapping of muskrats and mink. The Conibear type trap includes a pair of wire jaws biased toward a closed condition by a spring, and, when set, the trap assumes the shape of a pair of wire rectangles in side-by-side relationship with the trigger element extending toward the middle of the rectangles. When the trigger is displaced, the wire jaws quickly close on the animal.

The Conibear trap requires some sort of support or tie-down to keep it positioned correctly to trap animals and not be drug away from the trapping site. Stake supports are known which stake the trap in shallow water where mink and muskrat frequent. It has been observed that mink and muskrat tend to swim through water-containing culverts near the sidewall. It would be desirable to provide a support which easily mounts to the pipe of a culvert so as to support the trap near the inner wall at a level partially below the normal level of the water in a culvert. It would also be desirable that such a support allows the trap to break away from the support once an animal is trapped therein, while maintaining control of the trap for easy access to remove the trapped animal.

U.S. Pat. No. 416,755, issued Dec. 10, 1889, to schoenike describes an umbrella support or holder having an elongate body and a clamp for attachment to a permanent structure.

U.S. Pat. No. 579,735, issued Dec. 10, 1897, to Bower describes a support for a drum having a clamp having a lug for receiving a rod that is bent at its upper end to receive the hoop of the drum. The clamp may be used to attach the drum to a fixed object such as a chair. U.S. Pat. No. 1,858,713, issued May 17, 1932, to Martin, describes a trap fixed to a metal plate that mounts to a stake.

U.S. Pat. No. 4,019,795, issued Apr. 26, 1977, to Habuda, Sr. et al., describes a support using a beam clamp at one end of an elongate body.

U.S. Pat. No. 4,142,861, issued May 8, 1979, to Miller, describes a Conibear type trap holder having support fingers on a stake.

U.S. Pat. No. 2,947,107, issued Aug. 2, 1960, to Lehn, describes a Conibear type animal trap.

U.S. Pat. No. 3,010,245, issued Nov. 28, 1961, to Conibear, describes a Conibear type animal trap.

U.S. Pat. No. 4,458,394, issued Jul. 10, 1984, to Schultz, describes a stake fastener for a Conibear type animal trap having a collar fitting around a stake, and a support attaching between the jaws of the trap in the set position.

U.S. Pat. No. 5,437,122, issued Aug. 1, 1995, to Wilson, describes a rod holder having a clamping mount.

U.S. Pat. No. 4,020,585, issued May 3, 1977, to Benschoter, describes an animal trapping apparatus having a trap motor mounted to a rod by a generally L-shaped bracket having short vertical leg with an opening through which the rod is received, a long horizontal leg on which the motor is mounted, and a thumb screw to prevent the bracket from sliding along the rod.

None of the above inventions and patents, taken either singly or in combination, is seen to describe the instant invention as claimed. Thus a mink/muskrat trap holder solving the aforementioned problems is desired.

### SUMMARY OF THE INVENTION

The present invention is a support for mounting a Conbear-type animal trap within a culvert at about the water level near a wall thereof for trapping mink and muskrat which may be swimming through the culvert. The inventive support has an elongate body having a clamp at one end for clamping to the edge of the culvert pipe and a support or bracket at the other end for supporting the trap near the wall. The support may be a breakaway type where in one embodiment a bracket attached to the support body holds the trap in a desired position and allows the trap to break away from the support or bracket upon the trapping of an animal, the trap being attached at the clamp to avoid loss of the trap and animal.

In another embodiment a carriage bolt is substituted for one of the pivot pins or journals in the jaw eyes of the trap, the carriage bolt being secured to the end of the elongate body opposite the clamp. The bolt may be permanently secured by mounting through a throughbore in the body, or be mounted for breakaway in a V-shaped groove in the end of the support body, a chain being provided between the trap and the clamp for maintaining control of the trap. The breakaway configurations are more convenient for retrieving the trapped animal and resetting the trap without having to unclamp the support from the culvert pipe.

It is an aspect of the invention to include improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of a mink/muskrat trap support according to one embodiment of the present invention.

FIG. 2 is an environmental, perspective view of the trap support of FIG. 1 with the trap sprung and broken away.

FIG. 3 is an exploded view of the trap support of FIG. 1.

FIG. 4 is a plan view of the trap support of FIG. 1 as assembled.

FIG. 5 is an environmental, perspective view of another embodiment of the mink/muskrat trap support of the present invention.

FIG. 6 is an environmental, perspective view of the trap support of FIG. 5 with the trap sprung and broken away.

FIG. 7 is an exploded view of the trap support and bracket of the embodiment of FIG. 5.

FIG. 8 is an exploded view of a non-breakaway embodiment of a trap support similar to that shown in FIGS. 1 and 2.

FIG. 9 is a plan view of the embodiment of FIG. 8 as assembled.

Similar reference characters denote corresponding features consistently throughout the attached drawings.

### DETAILED DESCRIPTION OF THE PREFERRED EMBODIMENT

The present invention is a support for mounting a Conbear-type animal trap within a culvert at about the water level near a wall thereof for trapping mink and muskrat which may be swimming through the culvert. The support may be of the trap breakaway type or the fixed type.

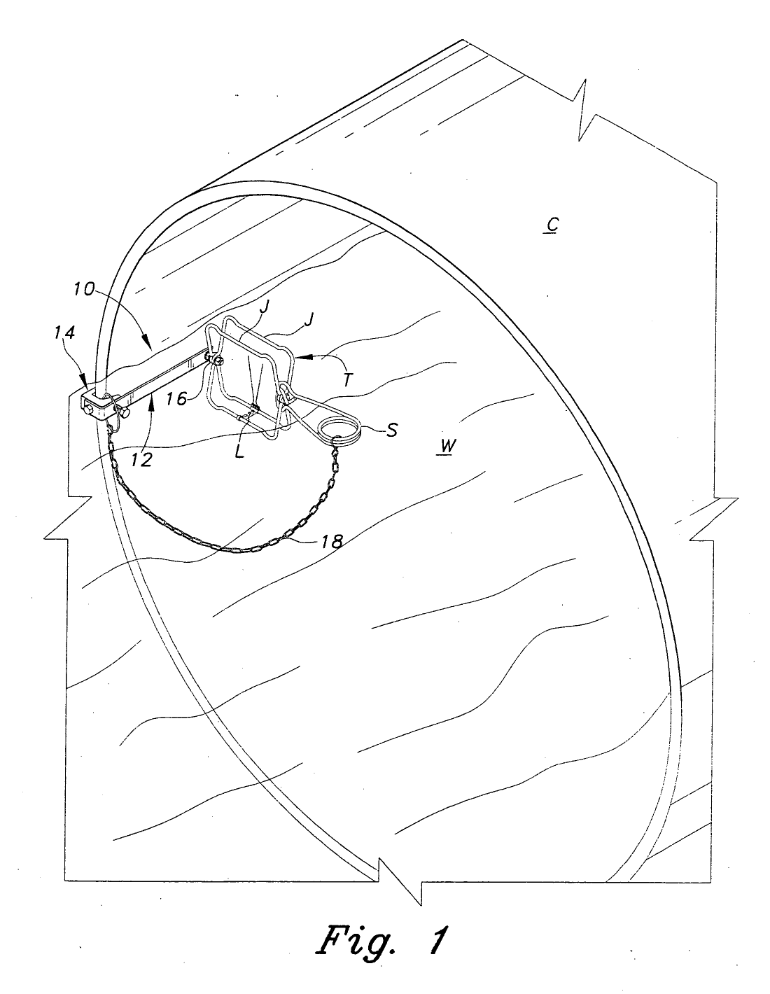

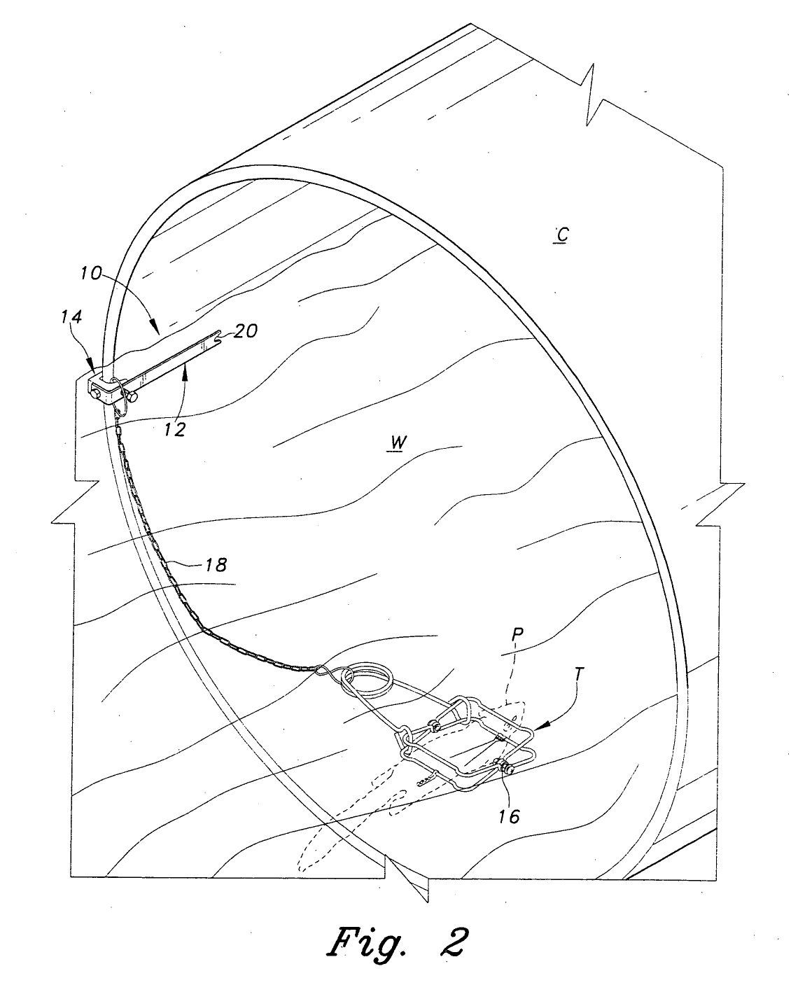

Referring to the Figures, one embodiment of the trap support system 10 is shown in FIGS. 1 and 2 wherein trap T is mounted on elongate body 12 at its inner end and held inward by breakaway trap axle 16 extending through a pair of eyelets of crossed jaws J. Trap support body 12 may be a steel flat of the desired length and is attached at its outer end to the edge of culvert pipe C by clamp 14 having its jaw against the outer side of culvert pipe C such the support body 12 is held axially proximate the inner wall of culvert pipe C. Clamp 14 may be a common beam clamp attached to the outer end portion of support body 12.

FIG. 1 shows the trap T in the set position with the releasable latch L holding the jaws J open against the force of spring S. A retaining chain 18 is connected between spring S and clamp 14.

FIG. 2 shows the trap T in a closed, breakaway position with jaws J holding prey P such as a mink which has tripped the trigger of trap T, releasing latch L (see FIG. 1). As is seen, breakaway trap axle 16 has broken away from the “V”-shaped slot inner end portion 20 of elongate body 12. The movements of the prey P are adequate to dislodge the breakaway trap axle 16 from the “V”-shaped slot end portion. The retaining chain 18 retains a connection between the trap T and the clamp 14, allowing the trapper to easily reach down to grasp the trap and prey, stand up and remove the prey P from trap T, reset the trap with latch L, and kneel to place the, reset trap on the “V”-shape slot end portion 20 of support body 12 by means of breakaway trap axle 16 frictionally engaging the edges of the “V ”-shaped slot.

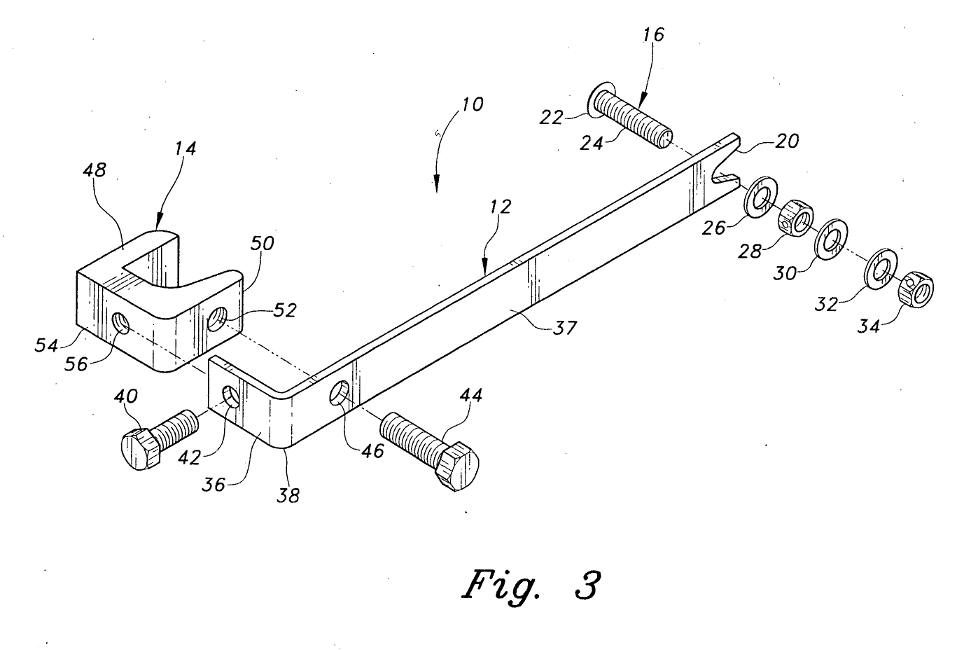

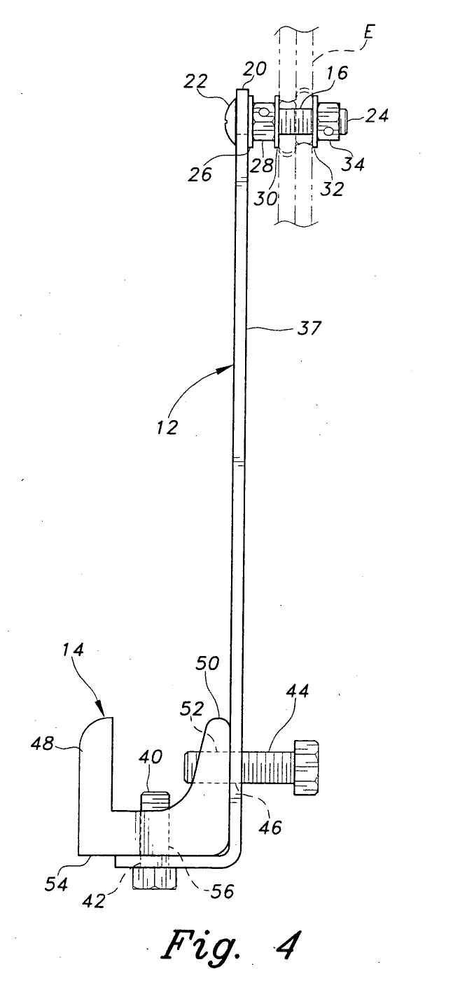

Referring to FIGS. 3 and 4, there is shown an exploded and a plan view, respectively, of the first embodiment of the breakaway trap holder system 10. The breakaway trap axle 16 is preferably a carriage bolt having a head 22 and a threaded body 24. A receiving washer 26 is held in place by a spacing self-locking nut 28 at a point along threaded body 24 so as to receive and frictionally engage the “V”-shape slot end portion 20 of support body 12. First trap eyelet washer 30 and second eyelet washer 32 form a gap along the carriage bolt body 24 for retaining eyelets E of the crossed jaws J (see FIG. 1), the second eyelet washer being held in place by eyelet retaining self-locking nut 34.

Body clamp attachment portion 36 forms the outer end of elongate body 12 and separated from inner end 20 by elongate portion 37 of body 12. Body clamp attachment portion 36 of elongate body 12 is positioned perpendicular to elongate portion 37 by right angle bend 38, wrapping around the body of clamp 14 for connection therewith, the attachment portion 36 extending outward relative to culvert pipe C. Clamp 14 is connected to attachment body portion 36 by means of clamp retaining bolt 40 extending through bore 42 of body attachment portion 36 and into threaded receiving bore 56 in the body 54 of clamp 14. The clamp 14 is also held in place by clamping bolt 44 extending through bore 46 of the body elongate -portion 37, extending through clamp base 50 by means of clamping bolt threaded bore 52. Clamping bolt 44 may be adjusted to lock the edge of culvert pipe C (see FIG. 1) against jaw 48 of clamp 14.

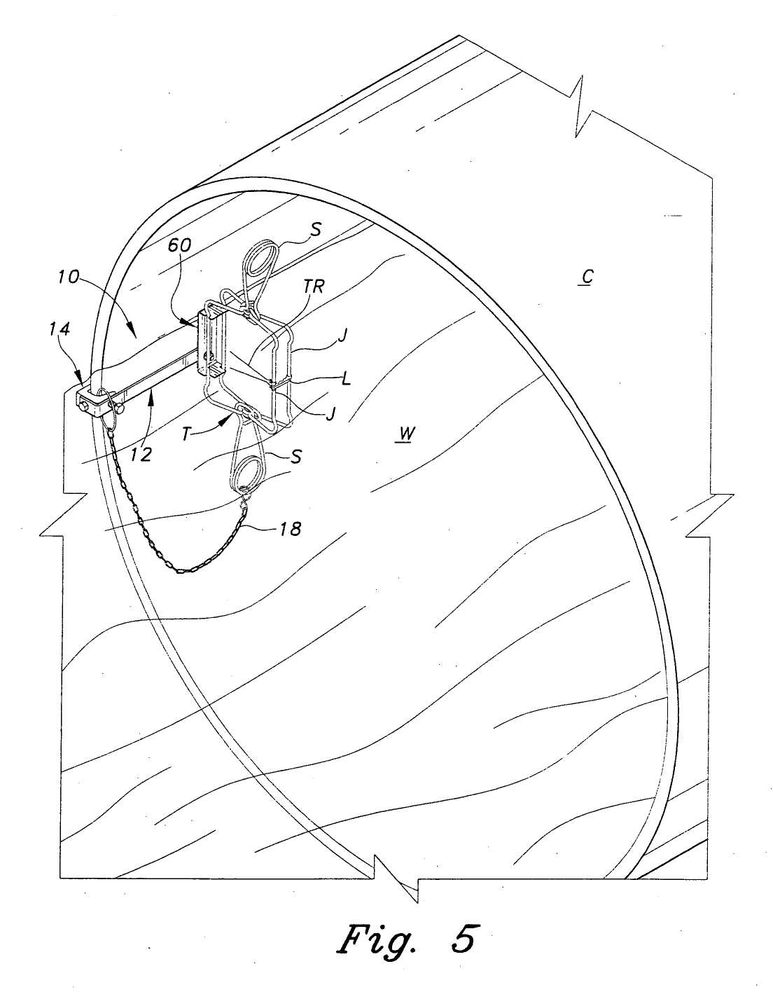

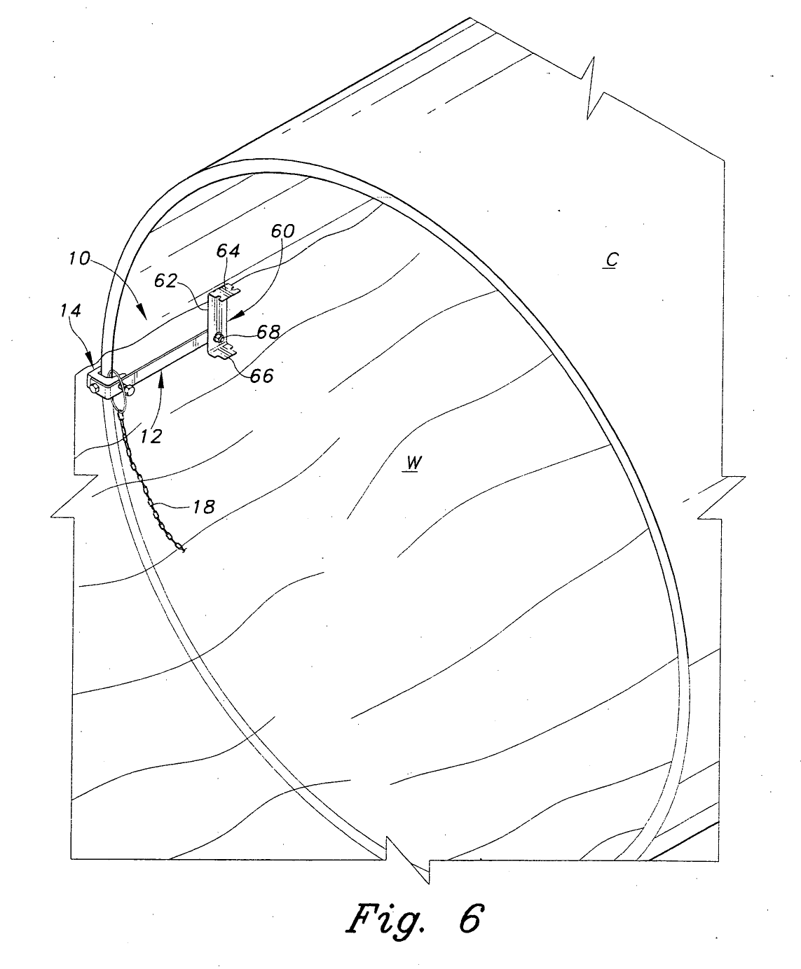

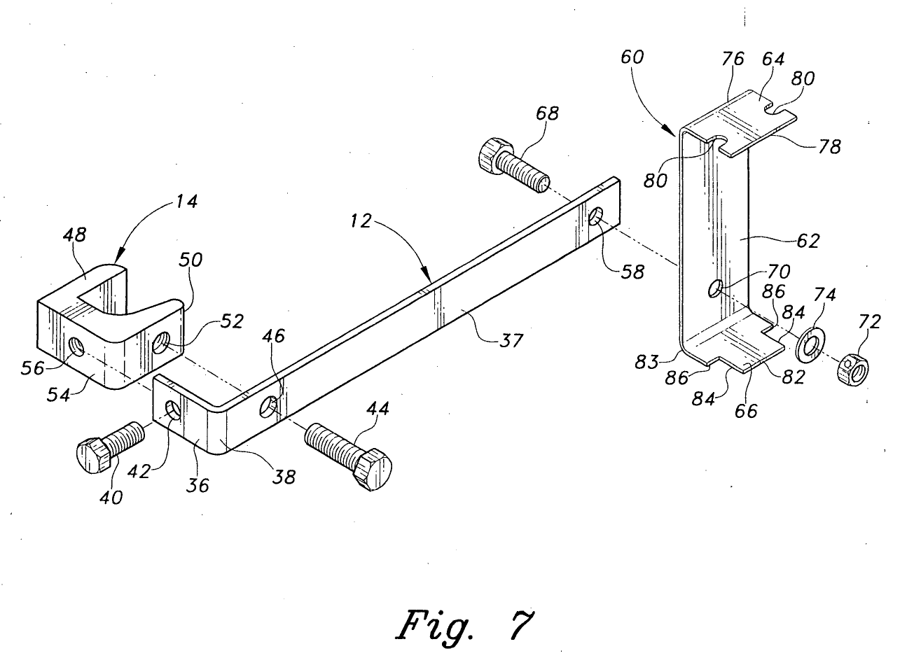

Referring to FIGS. 5 and 6, there are shown environmental perspective views, respectively, of another embodiment of the trap holder system 10 wherein a trap jaw bracket 60 is attached near the inner end of elongate body 12 for holding another version of the trap T having two springs S. The clamp 14 and remaining portions of the body 12 are identically configured to those of the first embodiment (see FIGS. 1 and 2). The bracket 60 has a vertical body 62 having upper jaw engagement portion 64 extending inward from body 62 and lower jaw engagement portion 66 extending inward from the lower end of body 62. Upper jaw engagement portion 64 and lower jaw engagement portion 66 are preferably bent perpendicular to vertical body 62. Vertical body 62 is attached near its lower end to body 12 by means of jaw bracket mounting bolt 68. As is shown in FIG. 5, the jaws J are supported opposite trigger TR and latch L by upper jaw engagement portion 64 in receiving notches 80 (see FIG. 7) and by lower jaw engagement portion 66 and by the shoulders 86 of receiving notches (see FIG. 7). As shown in FIG. 6, the bracket remains in place upon breakaway of the trap T. The trap T as tripped and broken away by prey P is similar to that shown in FIG. 2 and is not shown in FIG. 6.

Referring to FIG. 7, there is shown an exploded view of the embodiment of the invention shown in FIGS. 5 and 6. The elongate support body 12, the clamp 14, and the clamp mounting elements are identical to those as described above in the description pertaining to FIGS. 3 and 4 with the exception of the jaw bracket mounting bore 58 in an end portion being substituted for the “V”-shaped inner end portion 20. Mounting bore 58 is located near the inner end of elongate support body 12 for mounting jaw support bracket 60. Jaw support bracket 60 is generally rectangular in shape and includes a vertical, elongate bracket body 62, a perpendicular upper jaw engagement portion 64 extending outward from the upper end of bracket body 62, and a perpendicular lower jaw engagement portion 66 extending outward from the lower end of bracket body 62. Bracket body 62 has a mounting bore 70 through its lower portion.

Bracket body 62 is secured to support body 12 by a bolt 68 extending through bores 58 and 70 and a self-locking nut 72 and washer 74. Upper jaw engagement portion 64 extends inward from bracket body 62 at a right angle bend 76 to inner end 78. A pair of opposed side-cut upper jaw receiving notches 80 are equally spaced inward from outer end 78. Lower jaw engagement portion 66 extends inward from bracket body 62 at a right angle bend 83 to inner end 82. Opposed notches 84 extend along the outer sides of lower jaw engagement portion 66 from inner end 82, forming shoulders 86 at points about midway between bend 83 and inner end 82.

As shown in FIG. 5, the cross portions of the jaws J each have a vertical straight portion with a protruding round portion leading at each end to the side portions. In FIG. 5 with the trap set, the straight cross portions of jaws J opposite latch L and trigger TR fit within corresponding upper jaw receiving notches 80 so as to rest on the upper protruding round portions of the jaws. The straight cross portions bear against shoulders 86 and are held from moving crosswise by the sides of notches 84. In this manner, the trap is retained on bracket 60 when water travels in either direction through the culvert pipe C when in a set configuration, but easily falls away upon the trigger TR being hit by an animal resulting in the release of the latch L and the jaws J opening under the spreading force of springs S.

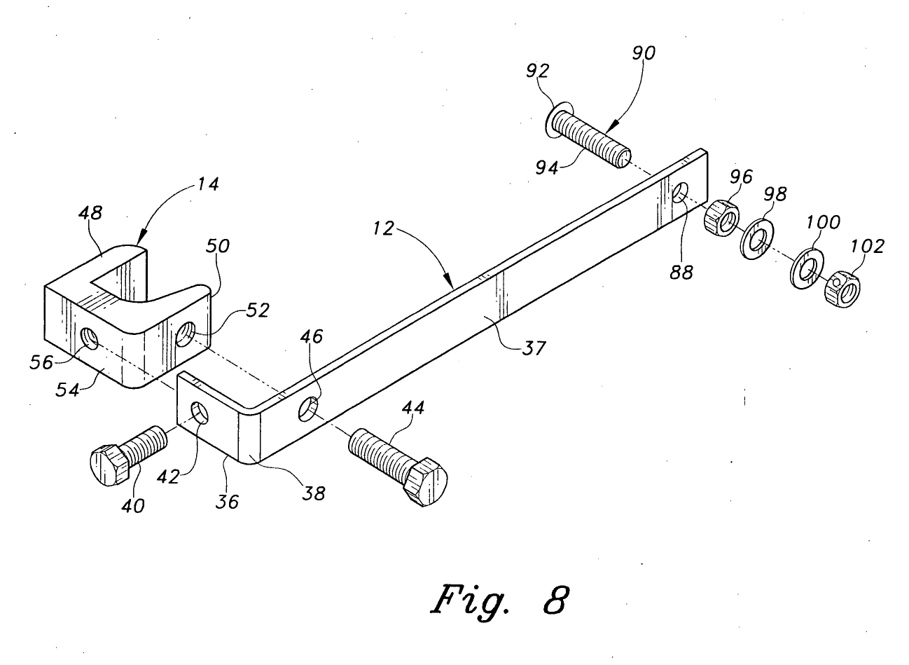

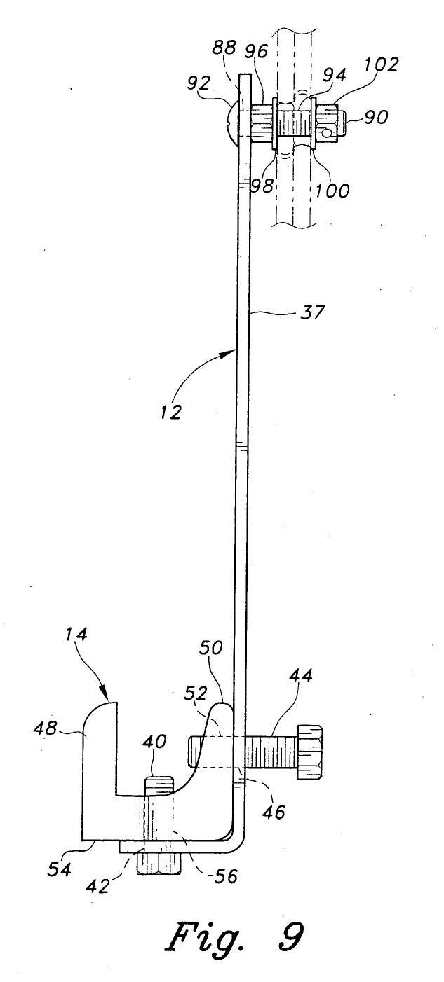

Referring to FIGS. 8 and 9, there is shown a third embodiment of the trap support of the present invention where the trap is permanently secured to the support and has no breakaway function. This embodiment is similar to that of FIG. 1, however the body 12 has a trap axle mounting bore 88 therethrough proximate the inner end. The clamp 14 and portions of the body 12 and their connections are identically configured to those as described above in the description pertaining to FIGS. 3 and 4 with the exception of the trap axle mounting bore

substituted for the “V”-shaped inner end portion 20. Fixed trap axle 90 includes a carriage bolt head 92 having a threaded body 94 inserted inward through mounting bore 88. A spacing nut 96 is snugly mounted on body 94 followed by first washer 98. The eyelets of one side of the trap are mounted over threaded body 94, followed by a second washer 100 and secured by a lock nut 102. In this embodiment the trapper must either remove the support from the culvert pipe edge or reach into the pipe to remove the trapped animal and reset the trap.

The trap supports of the embodiments of FIGS. 1-4 and 8-9 are useful in supporting a #110 Conibear trap, the pivot pin or journal opposite that of the spring side being removed and the carriage bolt axle of the present invention being substituted therefor. The #120 Conibear trap has springs covering both pivot pins and requires the jaw support bracket 60 of the second embodiment. The parts of the present inventive trap support are preferably steel or other appropriate metal, the components being selected from generally off-the-shelf items. Equivalent structures may have custom constructed parts while remaining within the scope of the present invention. Conibear traps useful with the present invention are available from Buckshot's Camp, Houghton, Mich.

The beam clamp may be welded to the outer end of the elongate body as an alternative to bending the body and bolting the clamp. An example is constructed with ⅛″ by ¾ inch 10-18 flat stock steel in an 8″ length as a support body. A 9/32″ hole is drilled near the inner end of the body through which a ¼× 1/14 inch carriage bolt is pressed through the 9/32″ hole. A ¼-inch nut is tightened on the bolt and two flat washers and a self-locking nut mounted on the bolt. The eyelets of a trap are mounted between the flat washers. A hole is drilled near the outer end of the support body to receive the tightening bolt of a beam clamp which is welded to the body on the side opposite the mounted trap. The support may then be clamped to a culvert in a position to catch mink and muskrat.

In the embodiment of FIGS. 5 and 6, the bracket 60 is preferably made of 16 gage sheet steel having a width of 1 ¼ inches and a length appropriate for the particular trap the vertical length of 2 ¾″ between upper and lower bends 76 and 83 of the bracket body 62 being preferred for the trap shown. The upper and lower jaw engagement portions 64 and 66 extend inward about 1″ from the bracket body 62. Other embodiments of the invention are of a similar scale and dimensions may be varied as desired. In the case of a corrugated pipe, the body of the support may be bent to conform to the inner side of the culvert.

It is to be understood that the present invention is not limited to the embodiments described above, but encompasses any and all embodiments within the scope of the following claims.

1. A breakaway mink/muskrat trap support, comprising: an elongate body having an inner end portion and an outer body clamp attachment portion;
a clamp connected to said elongate body at said outer attachment portion;
said outer clamp being so disposed on said elongate body so as to engage the circumferential edge of a culvert;
said inner end portion defining a “V”-shaped groove;
a bolt having a head and a threaded portion;
said threaded portion having a receiving washer secured in place by a first nut at a location so as to frictionally receive said outer end portion of said elongate body at said “V”-shaped groove;
said threaded portion being configured to receive a pair of eyelets of a Conbear-type trap thereon;
a second nut located on said thread portion securing said pair of eyelets on said threaded portion of said bolt; and
said threaded portion serving as a pivot for the operation of said trap.

2. The trap support of claim 1, wherein said first nut and said second nut are self-locking nuts.

3. The trap support of claim 1, further comprising a first trap eyelet washer located between said first nut and said pair of eyelets and a second trap eyelet washer located between said eyelets and said second nut.

4. The trap support of claim 3, wherein said first nut and said nut are self-locking nuts.

5. The trap support of claim 4, wherein said first self-locking nut is spaced from said bolt head such that said head and said washer frictionally engage said inner end portion of said body on opposite sides thereof at said “V”-shaped groove, whereby, upon said trap being sprung trapping prey, the force of the water against the prey disengages said bolt and said trap from said “v”-shaped groove.

6. The trap support of claim 5, wherein said trap extends radially inward relative to the circumferential edge of the culvert and said clamp extends radially outward from said body so as to removably engage the culvert.

7. The trap support of claim 6, wherein said clamp is a “C”-clamp having a body and a clamping bolt and said outer body clamp portion of said elongate body wraps around the outer end of said clamp body, said clamp body being attached to said outer body clamp attachment portion of said elongate body.

8. The trap support of claim 7, said elongate body having a right angle bend at said outer body end portion engaging said clamp body and said clamping bolt extends through said outer body clamp attachment portion to engage said clamp body.

9. The trap support of claim 1, wherein said elongate body extends axially inward relative to said culvert from said clamp to said “V”-shaped slot inner end portion.

10. The trap support of claim 5, further comprising a retaining chain extending between said clamp and the trap.

11. A breakaway mink/muskrat trap support, comprising:
an elongate body having an inner end portion and an outer body clamp attachment portion;
a clamp connected to said elongate body at said outer body clamp attachment portion;
said outer clamp being so disposed on said elongate body so as to engage the circumferential edge of a culvert;
a vertically disposed bracket connected to said elongate body at said inner end portion;
said bracket having an upper radially inward extending portion having opposed side cut grooves;
said bracket having a lower radially inward extending portion having opposed end grooves forming opposed shoulders along the sides thereof;
said opposed side cut grooves receiving and releasably supporting upper portions of respective straight, vertical cross bars of the jaws of a Conibear-type trap in the set position;
said shoulders releasably supporting lower portions of the respective straight, vertical cross bars of the jaws of the Conibear-type trap;
whereby, upon said trap being sprung trapping prey, the force of the water against the prey disengages the trap from said bracket.

12. The trap support of claim 11, further comprising a retaining chain extending between said clamp and said trap.

13. The trap support of claim 11, wherein said trap extends radially inward relative to the circumferential edge of the culvert and said clamp extends radially outward from said body so as to removably engage the culvert.

14. The trap support of claim 13, wherein said elongate body extends axially inward relative to said culvert from said clamp to said bracket.

15. The trap support of claim 14, wherein said clamp is a “C”-clamp having a body and a clamping bolt and said outer body clamp portion of said elongate body wraps around the outer end of said clamp body, said clamp body being attached to said outer body clamp attachment portion of said elongate body.

16. The trap support of claim 15, said elongate body having a right angle bend at said outer body end portion engaging said clamp body and said clamping bolt extends through said outer body clamp attachment portion to engage said clamp body.

17. A breakaway mink/muskrat trap support in combination with a Conibear-type trap, comprising:
an elongate body having an inner end portion and an outer body clamp attachment portion;
a clamp connected to said elongate body at said outer body clamp attachment portion;
said outer clamp being so disposed on said elongate body so as to engage the circumferential edge of a culvert;
a vertically disposed bracket connected to said elongate body at said inner end portion;
said bracket having an upper radially inward extending portion having opposed side cut grooves;
said bracket having a lower radially inward extending portion having opposed end grooves forming opposed shoulders along the sides thereof;
said opposed side cut grooves receiving and releasably supporting upper portions of respective straight, vertical cross bars of the jaws of a Conibear-type trap in the set position;
said shoulders releasably supporting lower portions of the respective straight, vertical cross bars of the jaws of the Conibear-type trap;
whereby, upon said trap being sprung trapping prey, the force of the water against the prey disengages the trap from said bracket.

18. The trap support of claim 17, further comprising a retaining chain extending between said clamp and said trap.

19. The trap support of claim 18, wherein said trap extends radially inward relative to the circumferential edge of the culvert and said clamp extends radially outward from said body so as to removably engage the culvert.

20. The trap support of claim 19, wherein said elongate body extends axially inward relative to said culvert from said clamp to said bracket.
